(19) United States
(12) Patent Application Publication
(10) Pub. No.: US 2026/0009422 A1
(43) Pub. Date: Jan. 8, 2026

(54) FASTENER ASSEMBLY FOR SECURING EQUIPMENT TO A BASE

(71) Applicant: Secure Outdoors LLC, Lithia, FL (US)

(72) Inventors: Ryan Hoover, Lithia, FL (US); Robbie Hunziker, Parrish, FL (US)

(73) Assignee: Secure Outdoors LLC, Lithia, FL (US)

(21) Appl. No.: 19/241,337

(22) Filed: Jun. 17, 2025

Related U.S. Application Data
(60) Provisional application No. 63/667,950, filed on Jul. 5, 2024.

(51) Int. Cl. F16B 41/00

(52) U.S. Cl. CPC F16B 41/005

(57) ABSTRACT

A fastener assembly for securing equipment to a base has a body defining a fastener receptacle, a fastener having a first portion configured to engage the base and operable to secure an equipment portion between the body and the base, the fastener having a second portion including a tool interface, a cover removably connected to the body, and movable between a closed configuration to deny access to the tool interface of the fastener and an open configuration to enable access to the tool interface of the fastener, a lock element operably connected to the cover and to the body, and the lock element operable between an unlocked condition enabling movement of the cover from the closed configuration to the open configuration, and a locked condition preventing movement of the cover from the closed configuration to the open configuration. The fastener may be a threaded bolt threadably engaging the base.

### CROSS-REFERENCE TO RELATED APPLICATION

This application claims the benefit of U.S. Provisional Patent Application No. 63/667,950 filed on Jul. 5, 2024, entitled “ELITE LOCK,” which is hereby incorporated by reference in its entirety for all that is taught and disclosed therein.

### FIELD OF THE INVENTION

The present invention relates to fasteners, and more particularly to a fastener assembly for securing equipment to a base that enables a wide range of equipment to be secured to a base in a theft-resistant manner.

### BACKGROUND AND SUMMARY OF THE INVENTION

With the outdoor industry growing, traveling around with expensive equipment attached to trucks and boats has become the norm. With that activity comes the need for security while traveling and staying in unfamiliar areas. To keep others from stealing expensive equipment that is removably attached to trucks and boats, companies have developed locks for specific products such as electronics and their gimbal mounts. However, these are often limited in terms of the range of equipment they are compatible with and their ability to withstand marine environments.

Therefore, a need exists for a new and improved fastener assembly for securing equipment to a base that enables a wide range of equipment to be secured to a base in a theft-resistant manner. In this regard, the various embodiments of the present invention substantially fulfill at least some of these needs. In this respect, the fastener assembly for securing equipment to a base according to the present invention substantially departs from the conventional concepts and designs of the prior art, and in doing so provides an apparatus primarily developed for the purpose of enabling a wide range of equipment to be secured to a base in a theft-resistant manner.

The present invention provides an improved fastener assembly for securing equipment to a base, and overcomes the above-mentioned disadvantages and drawbacks of the prior art. As such, the general purpose of the present invention, which will be described subsequently in greater detail, is to provide an improved fastener assembly for securing equipment to a base that has all the advantages of the prior art mentioned above.

To attain this, the preferred embodiment of the present invention essentially comprises a body defining a fastener receptacle, a fastener having a first portion configured to engage the base and operable to secure an equipment portion between the body and the base, the fastener having a second portion including a tool interface, a cover removably connected to the body, and movable between a closed configuration to deny access to the tool interface of the fastener and an open configuration to enable access to the tool interface of the fastener, a lock element operably connected to the cover and to the body, and the lock element operable between an unlocked condition enabling movement of the cover from the closed configuration to the open configuration, and a locked condition preventing movement of the cover from the closed configuration to the open configuration. The fastener may be a threaded bolt threadably engaging the base. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a schematic view of the current embodiment of a fastener assembly for securing equipment to a base constructed in accordance with the principles of the present invention in use securing an equipment panel to a boat.

FIG. 2 is a top isometric view of the fastener assembly for securing equipment to a base of FIG. 1.

FIG. 3 is an exploded view of the fastener assembly for securing equipment to a base of FIG. 1.

FIG. 4 is a top isometric view of the fastener assembly for securing equipment to a base of FIG. 1 with the lock element in the unlocked condition and the cover removed from the body.

FIG. 5 is a sectional isometric view of the fastener assembly for securing equipment to a base of FIG. 1 in use securing an equipment panel to a boat with the lock element in the locked condition.

The same reference numerals refer to the same parts throughout the various figures.

### DESCRIPTION OF THE CURRENT EMBODIMENT

An embodiment of the fastener assembly for securing equipment to a base of the present invention is shown and generally designated by the reference numeral 10.

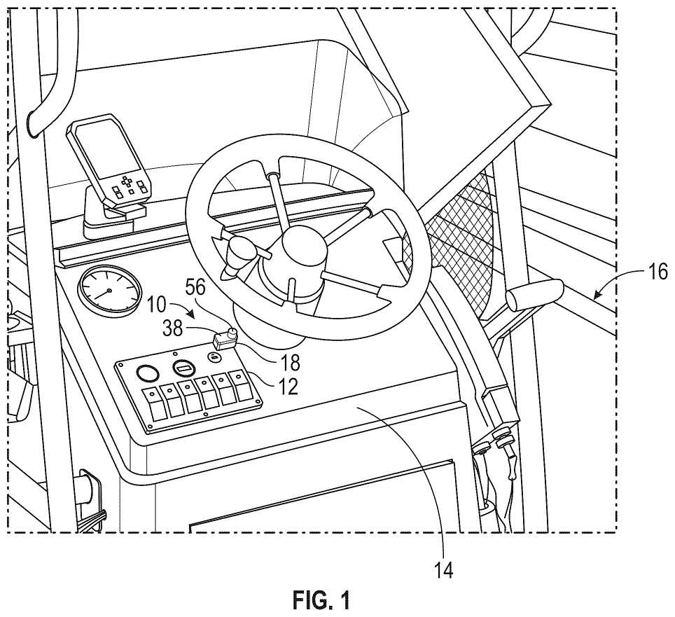

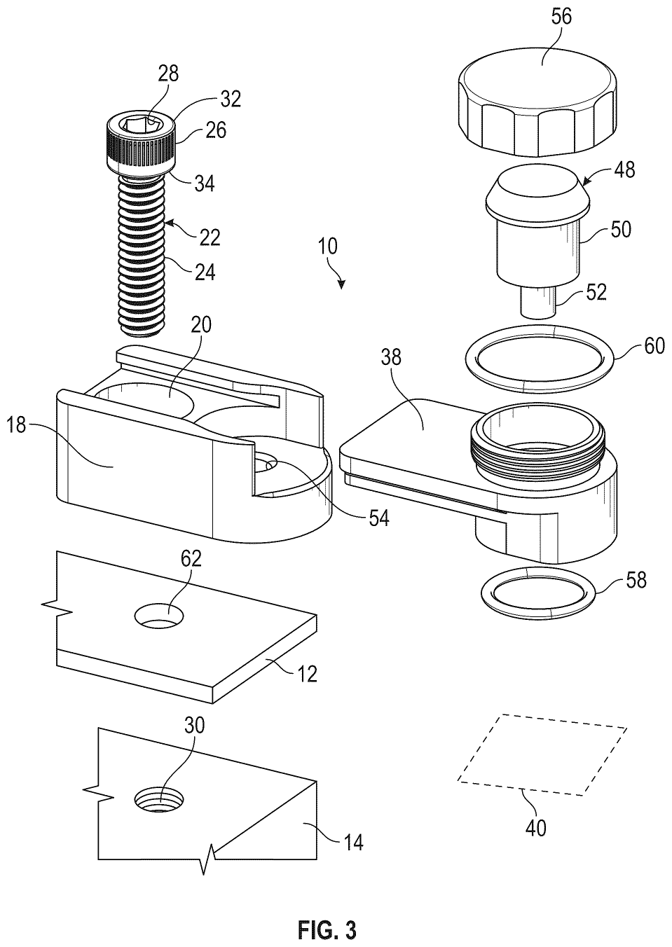

FIGS. 1-5 illustrate the improved fastener assembly for securing equipment to a base 10 of the present invention. More particularly, FIG. 1 shows the fastener assembly for securing equipment to a base in use securing an equipment panel 12 to the console 14 of a boat 16. The fastener assembly for securing equipment to a base has a body 18 defining a fastener receptacle 20. A fastener 22 is removably received within the fastener receptacle. The fastener has a first portion 24 configured to engage the base (in this case, the console) and operable to secure an equipment portion (in this case, the equipment panel) between the body and the base. The fastener has a second portion 26 including a tool interface 28. In the current embodiment, the fastener is a threaded bolt threadably engaging a threaded aperture 30 in the base and passing through a smooth bore 62 in the equipment panel. The second portion of the fastener is a fastener head 32 having a shoulder 34 bearing upon a surface 36 of the body facing away from the base. The fastener is preferably made of stainless steel or other strong material that is also corrosion resistant.

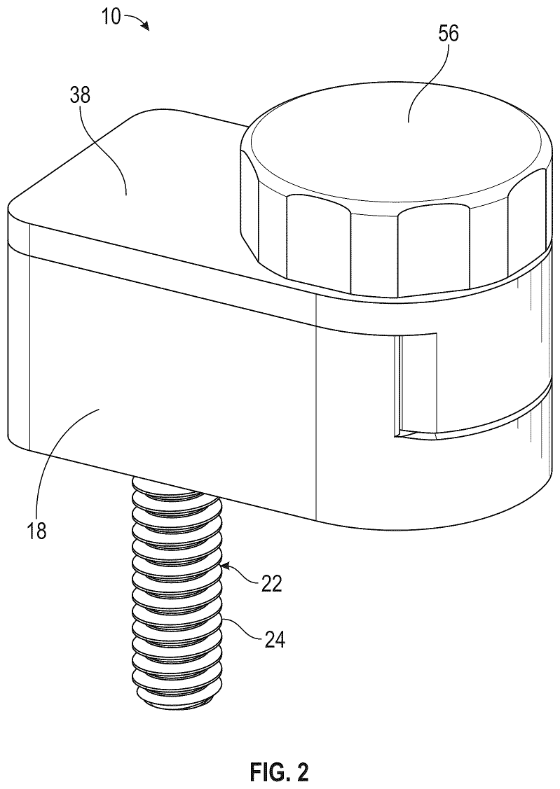

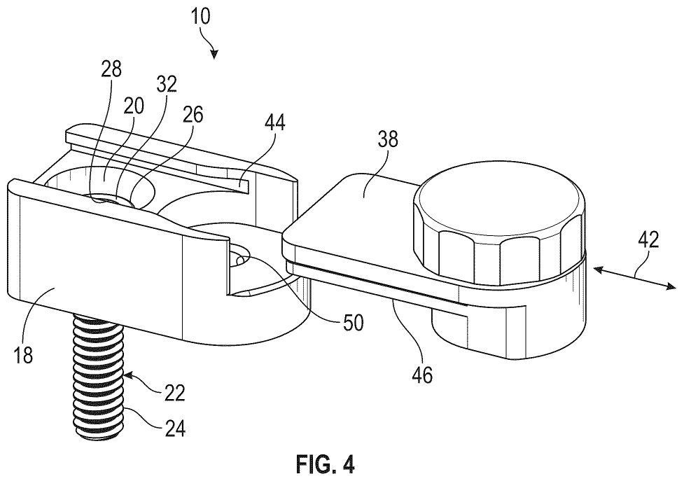

A cover 38 is removably connected to the body 18, and movable between a closed configuration to deny access to the tool interface 28 of the fastener 22 to prevent removal of the fastener from the base (console 14) and an open configuration to enable access to the tool interface of the fastener. The closed configuration is illustrated in FIGS. 1, 2 & 5, and the open configuration is illustrated in FIG. 4. The base defines a base plane 40, and the cover is movable parallel to the base plane as denoted by double-headed arrow 42 in FIG. 4. The body 18 defines parallel grooves 44 that receive protrusions 46 on either side of the cover to prevent vertical movement of the cover when the cover is installed on the body and to provide an environmental seal for the fastener receptacle 20 to prevent water intrusion.

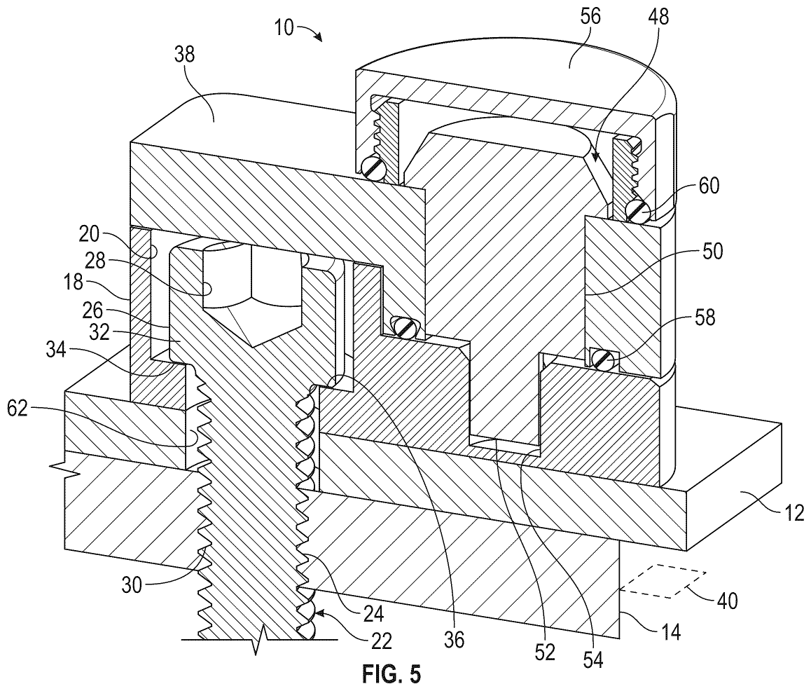

A lock element 48 is operably connected to the cover 38 and to the body 18. The lock element is operable between an unlocked condition enabling movement of the cover from the closed configuration to the open configuration as shown in FIG. 4, and a locked condition preventing movement of the cover from the closed configuration to the open configuration as shown in FIG. 5. More particularly, the lock element has a lock body 50 connected to the cover, and a movable bolt 52 operable in the locked position to engage the body (shown in FIGS. 1, 2 & 5) and in the unlocked position to disengage from the body and enable removal of the cover (shown in FIG. 4). In the current embodiment, the movable bolt engages the body by protruding into a bore 54 defined by the body. The lock element is preferably a model G1200 M12 small push lock manufactured by Dongguan Geheng Locks Co., Limited of Guangdong Province, China.

A cap 56 is threadably connected to the cover 38 and removably encloses the lock element 48. An environmental seal in the form of O-ring 58 interfaces the cover and the body 18 and surrounds the lock element. An environmental seal in the form of O-ring 60 interfaces the cover and the cap. The environmental seals prevent water from contacting the lock element.

While a current embodiment of a fastener assembly for securing equipment to a base has been described in detail, it should be apparent that modifications and variations thereto are possible, all of which fall within the true spirit and scope of the invention. Although connecting an equipment panel to the console of a boat has been described, the current invention is suitable for securing a wide range of items including, but not limited to, boat motors, anchoring systems, radios, and depth finders to a boat or other vehicle. Furthermore, the current invention can be used with a wide range of fastener types and could include the base having an upwardly protruding threaded portion with a nut received in the fastener receptacle. In addition, the equipment may have a protruding flange that receives the fastener. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A fastener assembly for securing equipment to a base comprising:
a body defining a fastener receptacle;
a fastener having a first portion configured to engage the base and operable to secure an equipment portion between the body and the base;
the fastener having a second portion including a tool interface;
a cover removably connected to the body, and movable between a closed configuration to deny access to the tool interface of the fastener and an open configuration to enable access to the tool interface of the fastener;
a lock element operably connected to the cover and to the body; and
the lock element operable between an unlocked condition enabling movement of the cover from the closed configuration to the open configuration, and a locked condition preventing movement of the cover from the closed configuration to the open configuration.

2. The fastener assembly of claim 1 wherein the fastener is a threaded bolt threadably engaging the base.

3. The fastener assembly of claim 1 wherein the second portion of the fastener is a fastener head having a shoulder bearing upon a surface of the body facing away from the base.

4. The fastener assembly of claim 1 wherein the base defines a base plane, and the cover is movable parallel to the base plane.

5. The fastener assembly of claim 1 wherein the lock element has a lock body connected to the cover, and a movable bolt operable in the locked position to engage the body and in the unlocked position to disengage from the body and enable removal of the cover.

6. The fastener assembly of claim 1 including an environmental seal interfacing the cover and the body and surrounding the lock element.

7. The fastener assembly of claim 1 including a cap connected to the cover and removably enclosing the lock element.

8. The fastener assembly of claim 7 including an environmental seal interfacing the cover and the cap.
